(19) United States
(12) Patent Application Publication
(10) Pub. No.: US 2006/0124862 A1
(43) Pub. Date: Jun. 15, 2006

(54) Point of infusion lighting device

(76) Inventor: Joel J. Rodriquez, Gloucester, MA (US)

Correspondence Address: FOLEY & LARDNER LLP, 111 HUNTINGTON AVENUE, 26TH FLOOR, BOSTON, MA, 02199-7610, US

(21) Appl. No.: 11/131,763

(22) Filed: May 18, 2005

Related U.S. Application Data
(60) Provisional application No. 60/654,360, filed on Feb. 18, 2005.

(30) Foreign Application Priority Data
Dec. 15, 2004 (WO) PCT/US04/42176

(51) Int. Cl. F21K 2/00

(52) U.S. Cl. 250/462.1

(57) ABSTRACT

The present invention provides devices for illuminating medical lines and devices. The illumination devices provide for rapid visual identification of the medical line, and the regions proximal to them and are particularly useful in field situations or emergency situations with low ambient light.

### RELATED APPLICATIONS

The present application is related to and claims the benefit of U.S. Ser. No. 60/654,360 filed Feb. 18, 2005 and U.S. Ser. No. 11/013,281 filed Dec. 15, 2004, and PCT Application No.: PCT/US2004/042176, filed Dec. 15, 2004, both of which in turn claim priority from: provisional Application Ser. No. 60/529,795, filed Dec. 16, 2003, provisional Application Ser. No. 60/542,747, filed Feb. 6, 2004, provisional Application Ser. No. 60/545,880, filed Feb. 19, 2004. Each application is hereby incorporated herein by reference in its entirety.

### FIELD OF THE INVENTION

The present invention relates to the field of medical equipment, and the illumination and control of the same.

### BACKGROUND OF THE INVENTION

The administration of medication, solutions and nutrients to patients via intravenous administration is a well established medical practice. In medical settings, patients are often treated by introducing prescribed medication or other prescribed liquids directly into the blood stream of the patient. This can be accomplished by direct instillation through an intravenous administration device.

A typical intravenous administration system consists of a length of sterile flexible plastic intravenous tubing. One end of the tubing is adapted to a supply reservoir such as a syringe or bag, typically containing a prescribed medication or other prescribed liquid. The other end of the tubing is adapted to be inserted into a venous blood vessel of the patient via a needle, or is capable of insertion into a device known as an infusion port, that is in turn coupled to a needle inserted appropriately into the patient. An infusion port is typically left in the patient for a prolonged period, and provides for a route of intravenous administration of one or more types of medications over a period of time, through a common injection site, for example intravenous (IV) drips provide the patient with continuous administration of saline and nutritional substances, and medications and other substances can be administered intermittently through the same port or through the same IV drip.

It is common in medicine, especially in an emergency room setting, for patients to receive simultaneous, multiple intravenous medications or solutions through intravenous tubing. The simultaneous use of multiple intravenous fluid lines has led to some major problems in the medical field.

The number of IV feeds and catheter lines in an operating theater, an intensive care room or emergency room can result in confusion to a medical practitioner as to which IV connection routes to particular insertion sites. Multiple intravenous tubes are long and transparent and frequently become entangled, intertwined or twisted, making it even more difficult for the medical care provider to determine which medication is flowing through which intravenous tube. Safety, timely delivery of medication, and efficiency are paramount to critical care. In routine emergency situations or during surgical procedures, quick identification of a medicinal fluid source is often required, but even in more simplistic and less time intensive procedures, accuracy remains critical. For example, administration of incorrect medication into a epidural line instead of an intravenous one would likely result in the death of the patient.

A number of devices and efforts were made to provide health care worker with systems for more rapidly identifying a medicament flow through an intravenous line. The references are briefly described, and the entirety of each disclosure is intended to be incorporated herein by reference. U.S. Pat. No. 6,059,768 to Friedman discloses a illumination system for intravenous tubing, where the tubing has a secondary axial cavity extending continuously along substantially an entire length of the tubing wall for visually distinguishing the tubing, the cavity being filled with a chemiluminescent material. This type of tubing is expensive to manufacture and use, and if the integrity of the tubing is compromised, the chemiluminescent solution may contaminate the medication. U.S. Pat. No. 6,613,012 to Kraushaar discloses a matched set of plural identification elements bearing matching identification symbols, wherein a first one of the set is attachable to the IV container; a second one of the set is attached to the drip chamber; and a third one of the set is attached to the IV line remote from the first and second identification elements in the set. U.S. Pat. No. 5,974,708 to Webb et al. discloses an intravenous line identification system that includes a plurality of sets of at least two identifying tags, each set used for identifying a medicinal source and a medicinal output for one of a plurality of intravenous lines. Each set is provided with a highly visible color distinct from every other set. Each tag in a set is coupled to another tag in the same set by at least one frangible or decouplable connection. Each tag further has an opening enabling the tag to be inserted over the intravenous line, and a preferably circular hole, about which the tag holds the intravenous line. For each intravenous line, the tags are applied over the intravenous line as a set, i.e., while coupled. Once on the intravenous line the tags are decoupled from each other and slid in opposite directions along the line toward the medicinal source and output.

However, there remains a need for an improved intravenous identifying system that can provide enhanced visual identification of medical lines.

### SUMMARY OF THE DRAWINGS

FIG. 1 is an illustration of a point of infusion lighting device for a medical line.

### SUMMARY OF THE INVENTION

In one aspect the invention provides a medical illumination apparatus including, a substrate and an illumination source; the substrate having a first channel capable of receiving and securing the illumination source, and further comprising a second channel capable of receiving and securing a medical line or device. In one embodiment, the substrate further comprises geometric features that engage the medical line or device. In another embodiment, the engaged geometric features irreversibly lock the substrate in a closed position, thereby preventing removal of the substrate from the medical line or device. In yet another embodiment, the illumination source is chemiluminescent. In even another embodiment, the illumination source provides light of a particular color. In still another embodiment, the invention includes a second illumination source, wherein the second illumination source is a different color from the first illumination source.

In another aspect, the invention provides a method of illuminating the area proximal to a medical procedure including the steps of: obtaining a medical illuminating apparatus comprising a substrate and an illumination source; the substrate having a first channel capable of receiving and securing the illumination source, and further comprising a second channel capable of receiving and securing a medical line or device; isolating a medical line or device to be identified; and activating the illumination source and affixing the medical line illumination apparatus to a medical line, thereby illuminating a portion of the medical line and approximately 100 cm2 area surrounding the medical line or device. In one embodiment, the illumination source provides sufficient illumination to assist a medical procedure. In another embodiment, the medical procedure is venipuncture. In yet another embodiment, the medical procedure occurs in a low light environment. In still yet another embodiment, the illumination source is chemiluminescent. In even another embodiment, the invention provides a second illumination source that provides light of a particular color different from the first illumination source.

In another aspect, the invention provides a kit for illuminating a medical procedure comprising, a medical illuminating apparatus further comprising a substrate and an illumination source; the substrate having a first channel capable of receiving and securing the illumination source, and further comprising a second channel capable of receiving and securing a medical line or device, the kit further comprising suitable packaging material and instructions for using the apparatus to illuminate a medical procedure. In one embodiment, the illumination source is chemiluminescent. In another embodiment, the illumination source provides light of a particular color. In even yet another embodiment, the kit includes a second illumination source, wherein the second illumination source is a different color from the first illumination source. In still another embodiment, the contents are sterile. In another embodiment, the packaging material provides a hermetic seal that indicates the sterility of the device contained therein. In yet another embodiment, the packaging material is chemically compatible with ethylene oxide sterilization, and approved by the FDA or a regulatory authority for use as sterile packaging for medical devices.

In another aspect, the invention provides a method of making a kit for illuminating a medical procedure comprising, obtaining the medical line illuminating apparatus of claim 1; obtaining suitable packaging material and instructions for using the device, and incorporating the device into the packaging material.

These and other embodiments are set forth in greater detail below.

### DETAILED DESCRIPTION

The present invention provides point of infusion illumination sources for medical lines and devices. An illuminated device is attached to a medical line or device proximal to the point of infusion, i.e., near the needle, near the port, on the syringe barrel, or otherwise close to the body of the patient. Alternatively, the illumination source is positioned proximal to a medication supply, or proximal to medical line adaptor sets, to illuminate the area nearby. The illumination source illuminates everything within the field of the light source, for example, within 10 cm², 100 cm² or 500 cm² or more of the source of light emission.

As used herein, a medical line refers to a conduit having two terminal ends, one that is adapted to a medical device, and the second end capable of direct insertion into a patient or capable of adaptation to a second medical device that is directly inserted into the patient. A nonlimiting example of a medical line that is adapted to a first and a second medical device is a medication line, such as an i.v. drip, where the line provides for fluid communication between a medication source and a needle inserted into the patient. A nonlimiting example of such a medical line that is adapted to a medical device and is directly inserted into a patient is a catheter, which is typically a hollow flexible tube for insertion into a body cavity, duct, or vessel to allow the passage of fluids or distend a passageway. Another example is a syringe; the barrel is the fluid conduit.

Preferably, the illumination source includes a diffusing lens, to provide flood lighting of the infusion area. This increases the surface area that is illuminated. Other embodiments employ a focusing lens to concentrate the light, or otherwise direct or restrict light emissions. Light emissions can also be restricted temporally, i.e., by quick burning chemical lights having short lifespans.

Advantageously, direct lighting of the infusion point (or region) aids medical personnel in, e.g., locating the veins of a patient, which can be difficult to locate in small children, persons with darker skin pigmentation (e.g., African Americans, Hispanics, Indians) and persons having extremely light skin (persons of Northern European descent). The point of infusion lighting source allows light directed on the skin, to travel through the skin of the patient, thereby illuminating or highlighting the veins. Color spectrum of the illumination source can be selected to more particularly distinguish blood vessels. Preferably an illumination source with an amber/orange hue is used, which aids in the identification of subcutaneous blood vessels, because it visually renders vessels black while rendering skin tones white (or light). For other procedures, such as catheterization, the device provides a localized light source. In such applications, a white hue is preferable. In low ambient light environments red, blue or green hues allow localized lighting without harsh contrast that would reduce the operator's night vision.

Pair sets of illuminated medical devices, attached to the medical device near the point of infusion and proximal to the medication source, are preferred. If the device is intended to be removable, the substrate is modified accordingly, e.g., spring clips are incorporated into the substrate instead of locking tabs, allowing detachment from a medical line.

In a preferred aspect, the illumination system is applied to medical lines and devices used for the administration of medications, nutrients, or fluids to the patient. Such lines can be intravenous lines, which provide for fluid communication from medication sources to the veins of the patient, wherein the illumination system provides for identification of specific lines used to deliver (infuse) each specific medication, as well as point of infusion lighting, which illuminates the site of the medical procedure. Other such lines include an epidural line, which provides for fluid communication from medication sources to the intraspinal spaces of the patient, wherein the illumination system provides for identification of this epidural line and the point of infusion, and further provides a signal that only specific medications are to be introduced through this particular line. In administering anesthesia to patients, it is highly critical that arterial lines, venous and swan lines be clearly identified and marked. The invention is also useful with medical lines attached to devices, such as an angioplasty catheter, wherein the device provides for identification of the lines that are adapted to the inflation/deflation source. Alternatively, where the catheter is a bladder catheter, the system provides for identification of the line that is adapted to a medical waste container. Similarly, the system is applied to medical lines adapted to medical devices for example but not limited to, irrigation lines, aspiration and suction lines, gas supply lines, and electrical lines such as those attaching to monitors. In addition, the system is applied to medical devices such as syringes. A skilled artisan will recognize that the function of the medical line does not limit the applications for the invention, which can be used with virtually any tube, conduit, line, hose, wire, syringe or similar medical device or line.

The medical illumination system is preferably a self-illuminating device that provides visual identification of medical lines and the areas around them in low ambient light environments, common in many surgeries, hospital wards, and field environments. The illumination device is comprised of a substrate that is affixed along part of a length of a medical device or line. The substrate provides a structural frame that is adapted to receive and contain an illumination source. Preferred materials for the substrate include polypropylene, polyethylene, and other common plastic materials. The substrate can be transparent or semitransparent, or can be opaque provided it has one or more apertures or windows, through which a user may view the illumination source, or light therefrom. Alternative embodiments having variously sized and shaped apertures are suitable for applications where it is desirable to direct light emissions from the substrate to a particular illumination field. The substrate has one or more geometric features that provide a reversible clamp or irreversible locking mechanisms to hold the illumination source, for example a clip designed to close over a medical line where the substrate unit is designed to fold upon itself, thereby bringing the geometric features into proximity whereby they engage each other and lock the substrate in a closed position. In such a closed position, the illumination source is secured inside the substrate. The substrate has a semicircular groove or channel, or alternatively a series of apertures in the structural frame, such that the substrate can receive the medical line or otherwise surround and adhere to a syringe. The appropriate diameter of the channel will depend on the outside diameter of the medical line or device as described above. The substrate will encompass and contain the medical line or device, in such manner that the line or device passes through the illuminated medical device. In a preferred embodiment, the device is irreversibly attached to the medical line or device. In various other embodiments, the substrate includes words or symbols or other identifying and distinguishing features, which can be inscribed upon or formed into the substrate. The self-illuminating device provides a source of localized illumination, wherein medical devices and/or controls in proximity to the device, i.e., within the luminescent field, are thereby illuminated. If the device presents imprinted data or formed features (as described above), such are preferably illuminated by the illumination source.

The illuminated medical line illumination system includes an illumination source. The illumination source can be, for example, an LED or bulb. Controls and power supplies would thus be provided, which can be remote, or integrated into the substrate. Alternatively, an optical fiber can be introduced into the device. But preferably, the illumination source is a self contained unit. A small chemiluminescent device is a suitable self-contained illumination source, and provides a bright cool light for many hours. A Cyalume®-type chemical light stick exemplifies such a chemiluminescent device.

An additional feature of the point of infusion lighting device, i.e., PIN-LITE™ employs one or more second smaller light sticks which are attached on the side of the substrate mounting clip that holds the larger illuminating light stick. Second light sticks are generally miniature sized light sticks having approximate dimensions of 0.750 inch by 0.065 inch in size, as a nonlimiting example. Small button style lights approximating the size of a watch battery are also suitable. In various embodiments, these secondary lights are self-adhesive. The purpose of this attached second small light, is to provide medication identification on a particular syringe while sitting on a procedure table. Presently, in an operating theater, various syringes lay on the table, and when it is dark, medical personnel have a difficult time in distinguishing what syringe contains a particular medication. With the second mini colored light applied on the side of the substrate in turn attached to the syringe, medical personnel can instantly be able to identify the appropriate syringe and medication therein, in accordance with a color code system.

The user activates the illumination source, e.g. bends the stick, prior to insertion of the illumination source into the substrate. In one embodiment, the illumination source does not display a long life after activation, but supplies very high lumens for a short period of time. In another embodiment, the illumination source has a lifespan of several hours after activation, for example, 1, 2, 3, 4, 5 hours or more, and supplies lower intensity light for a period of time. For example, a 2 in. diameter ultra-bright illumination source would be used as a local “vein illuminator” for neonates or elderly patients in hospital settings. The illumination source preferably emits a colored light, thus providing illumination but also permitting rapid visual identification of the line, e.g., red for an epidural catheter line, green and blue for a set of intravenous medication lines, and yellow for a medical waste catheter. Chemiluminescent devices that emit various color spectra are commonly available, such as those from OmniGlow, Inc. In certain embodiments, a single illumination source is employed, that provides two or more discrete regions of color, such as dual color chemical light sticks. Color lenses may also be incorporated into one or more regions of the substrate to provide additional multi-color effects.

The illumination and identification systems described are suitable for incorporation into a kit for surgical and medical uses. An illumination system kit includes any of the following: one or more illuminated medical devices, substrates for attachment to medical equipment, suitable packaging materials and instructions for use. Kit contents may be sterilized, in which case the packaging material can be hermetically sealed. Sterilization techniques for medical devices are well known in the art, for example, irradiation or ETO—Ethylene Oxide gas are both suitable for sterilizing the invention. In another embodiment, the kit packaging has a label backer made of Tyvek® (DuPont), the only FDA approved material for use in sterile packaging employing an ETO—Ethylene Oxide gas sterilization technique. Kits preferably include multiple color sets (illumination sources or lenses). Pair sets of colors are particularly preferred.

### EXAMPLE ONE

### A Point of Infusion Medical Illumination Device

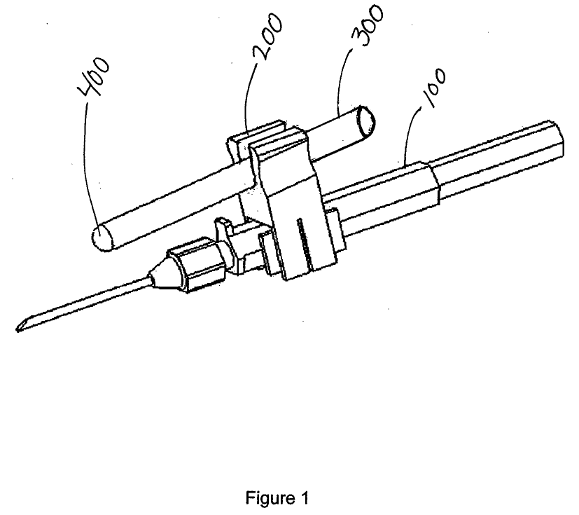

A point of infusion medical illumination device is provided. The device is shown in FIG. 1 adapted to a medical line 100. The device includes a substrate 200 capable of receiving and containing an illumination source 300, illustrated as a cylindrical glow stick. The illumination source is activated, and light is focused through a lens 400 to provide illumination for an area proximal to the terminal end of a medical line (illustrated as the needle end of an intravenous line).

Equivalents

From the foregoing detailed description of the specific embodiments of the invention, it should be apparent that unique medical devices and identification systems have been described. Although particular embodiments have been disclosed herein in detail, this has been done by way of example for purposes of illustration only, and is not intended to be limiting with respect to the scope of the appended claims which follow. In particular, it is contemplated by the inventor that various substitutions, alterations, and modifications may be made to the invention without departing from the spirit and scope of the invention as defined by the claims. For instance, the choice of color spectrum, or the illumination source used is believed to be matter of routine for a person of ordinary skill in the art with knowledge of the embodiments described herein.

All references referred to in this specification are hereby incorporated herein in their entirety.

I claim:

1. A medical illumination apparatus comprising, a substrate and an illumination source; the substrate having a first channel capable of receiving and securing the illumination source, and further comprising a second channel capable of receiving and securing a medical line or device.

2. The apparatus of claim 1, wherein the substrate further comprises geometric features that engage the medical line or device.

3. The apparatus of claim 2, wherein the engaged geometric features irreversibly lock the substrate in a closed position, thereby preventing removal of the substrate from the medical line or device.

4. The apparatus of claim 1, wherein the illumination source is chemiluminescent.

5. The apparatus of claim 1, wherein the illumination source provides light of a particular color.

6. The apparatus of claim 1, further comprising a second illumination source, wherein the second illumination source is a different color from the first illumination source.

7. A method of illuminating the area proximal to a medical procedure comprising:
a. obtaining a medical illuminating apparatus comprising a substrate and an illumination source; the substrate having a first channel capable of receiving and securing the illumination source, and further comprising a second channel capable of receiving and securing a medical line or device;
b. isolating a medical line or device to be identified; and
c. activating the illumination source and affixing the medical line illumination apparatus to a medical line, thereby illuminating a portion of the medical line and approximately 100 cm² area surrounding the medical line or device.

8. The method of claim 7, wherein the illumination source provides sufficient illumination to assist a medical procedure.

9. The method of claim 8, wherein the medical procedure is venipuncture.

10. The method of claim 8, wherein the medical procedure occurs in a low light environment.

11. The method of claim 8, wherein the illumination source is chemiluminescent.

12. The method of claim 8, wherein the apparatus provides a second illumination source that provides light of a particular color different from the first illumination source.

13. A kit for illuminating a medical procedure comprising, a medical illuminating apparatus further comprising a substrate and an illumination source; the substrate having a first channel capable of receiving and securing the illumination source, and further comprising a second channel capable of receiving and securing a medical line or device, the kit further comprising suitable packaging material and instructions for using the apparatus to illuminate a medical procedure.

14. The kit of claim 13, wherein the illumination source is chemiluminescent.

15. The kit of claim 13, wherein the illumination source provides light of a particular color.

16. The kit of claim 13, further comprising a second illumination source, wherein the second illumination source is a different color from the first illumination source.

17. The kit of claim 13, wherein the contents are sterile.

18. The kit of claim 17, wherein the packaging material provides a hermetic seal that indicates the sterility of the device contained therein.

19. The kit of claim 17, wherein the packaging material is compatible with ethylene oxide sterilization.

20. A method of making a kit for illuminating a medical procedure comprising, obtaining the medical line illuminating apparatus of claim 1; obtaining suitable packaging material and instructions for using the device, and incorporating the device into the packaging material.
